(19) United States
(12) Patent Application Publication
(10) Pub. No.: US 2010/0153236 A1
(43) Pub. Date: Jun. 17, 2010

(54) AUTOMATED PRICE QUOTE GENERATION

(75) Inventors: L. Thomas Mohr, San Jose, CA (US); Jagdish Rajan, Fremont, CA (US); Timothy D. Weaver, San Jose, CA (US)

Correspondence Address: CARR & FERRELL LLP, 2200 GENG ROAD, PALO ALTO, CA, 94303, US

(73) Assignee: ResponseLogix, Inc., Sunnyvale, CA (US)

(21) Appl. No.: 12/705,515

(22) Filed: Feb. 12, 2010

Related U.S. Application Data
(63) Continuation of application No. 12/475,368, filed on May 29, 2009.
Application No. 12/475,368 is a continuation-in-part of application No. 12/215,940, filed on Jun. 30, 2008.
(60) Provisional application No. 60/937,856, filed on Jun. 30, 2007.

(51) Int. Cl. G06Q 30/00; G06Q 50/00; G06Q 10/00; G06F 17/30

(52) U.S. Cl. 705/27; 707/769; 707/802; 707/E17.014; 707/E17.044

(57) ABSTRACT

Methods and systems for automated price quote generation are provided. A requesting party submits a request that includes information regarding a geographic location and at least one specification. A database is searched based on the information provided by the request. A price quote is automatically generated based on at least the results of the search and provided to the requesting party. The requesting party may be a potential customer, a dealer, or a third party acting on behalf of the potential customer or dealer.

### CROSS-REFERENCE TO RELATED APPLICATIONS

The present application is a continuation and claims the priority benefit of U.S. patent application Ser. No. 12/475,368 filed on May 29, 2009, which is a continuation-in-part of U.S. patent application Ser. No. 12/215,940 filed on Jun. 30, 2008, which claims the priority benefit of U.S. provisional patent application No. 60/937,856 filed Jun. 30, 2007, the disclosures of which are incorporated herein by reference.

### BACKGROUND

1. Field of the Invention

The present disclosure relates generally to pricing. Specifically, the present disclosure relates to automating the generating of price quotes by geography.

2. Background Art

When making purchases, one of the most important considerations for a buyer is price. However, pricing can be dependent on multiple factors: including type of item, specifications and features of the item, age, degree of use (i.e., used, new), location, seller/dealer, etc. Such factors may affect the price dramatically and further complicate the process of determining, analyzing, and comparing prices for a desired product. Automobiles, for example, may come in various makes, models, colors, trim, features, etc. Such options and upgrades, or removal thereof, may increase or decrease the price of the final product.

Another consideration when customers are shopping for a particular product is availability, specifically availability within a certain geographic region. Many customers wish to see, touch, and test a product before committing to a purchase, especially costly purchases. Some items, due to size, weight, rarity, etc., may be difficult, costly, or time-consuming to transport to the customer. As such, the customer may wish to find a seller or dealer of the product within a certain geographic region that is convenient to the customer. The geographic location of a car dealer, for example, may be an important factor to a car-buyer, since transporting an automobile from a distant location may be either costly, time-consuming, or both. Determining availability within a geographic region therefore becomes very important to the customer.

As such, there is therefore a need in the art for improved systems and methods for automatic generation of price quotes.

### SUMMARY OF THE INVENTION

Exemplary methods and systems for generating price quotes are provided. A requesting party submits a request that includes information regarding a geographic location and at least one specification. A database is searched based on the information provided by the request. A price quote is generated based on at least the results of the search and provided to consumer 110. The requesting party may be a potential customer, a dealer, or a third party acting on behalf of the potential customer or dealer.

Embodiments of the present invention include methods for generating price quotes. Such methods may include receiving a price quote request from a requesting party, the price quote request comprising information concerning a geographic location and at least one product specification, searching a database based on at least the information concerning the geographic location and the at least one product specification provided by the price quote request, generating a product price quote based on the search of the database, and providing the determined product price quote to consumer 110. For automobiles, specifications may include year, make, model, color, trim, option, vehicle identification number (VIN), and dealer name. Some embodiments further provide for notifying the dealer concerning the price quote. For automobiles, various pricing schemes may take consumer's distance from dealership, inventory age and degree of vehicle use into account.

Further embodiments of the present invention include systems for generating price quotes. Such systems may include an interface configured to receive a price quote request from a requesting party. The price quote request may include information concerning a geographic location and at least one product specification. Systems may further include a memory configured to store information concerning product availability associated with geographic location and a processor configured to execute instructions stored in memory to search memory based on at least the information concerning the geographic location and the at least one product specification provided by the price quote request and to generate a product price quote based on the search of the database.

Embodiments of the present invention may further include computer-readable storage media having embodied thereon programs executable by a processor to perform a method for generating price quotes. Such computer-readable storage media may provide for performance via integration into existing client systems and/or via plug-in.

### BRIEF DESCRIPTION OF THE FIGURES

FIG. 1A illustrates an exemplary architecture for generating a price quote.

FIG. 1B illustrates an alternative architecture for generating a price quote according to another embodiment of the present invention.

FIG. 2 illustrates an exemplary embodiment of a quoting engine system for generating a price quote.

FIG. 3 illustrates an exemplary architecture for receiving dealer information.

FIG. 4 illustrates an exemplary method for generating a price quote.

FIG. 5 illustrates an exemplary implementation of a pricing scheme.

### DETAILED DESCRIPTION

Embodiments of the present invention include systems and methods for generating price quotes. A requesting party submits a request that includes information regarding a geographic location and at least one product specification. A database is searched based on the information provided in the request. A price quote is generated based on at least the results of the search and provided to consumer 110. The requesting party may be a potential customer, a dealer, or a third party acting on behalf of the potential customer or dealer. The automated nature of such a price quote provides a customer with information that is timely, detailed and accurate with respect to pricing, as well as with respect to availability. Such price quoting also provides dealers with speed of response to the requesting party, more pricing flexibility, greater accuracy, and significant time savings.

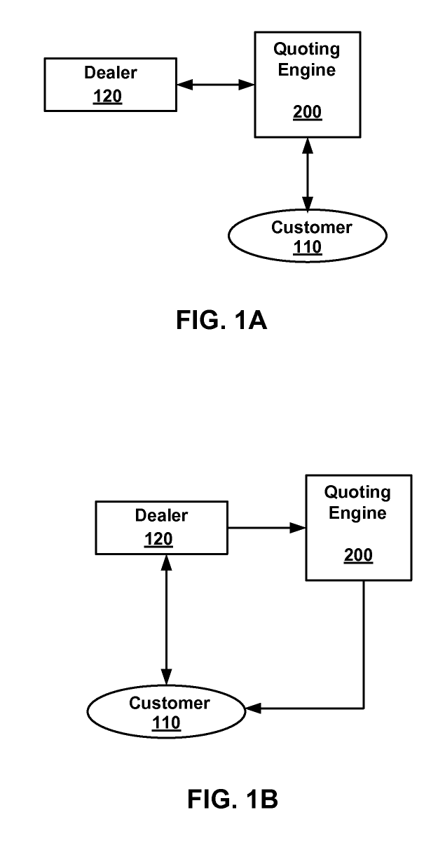

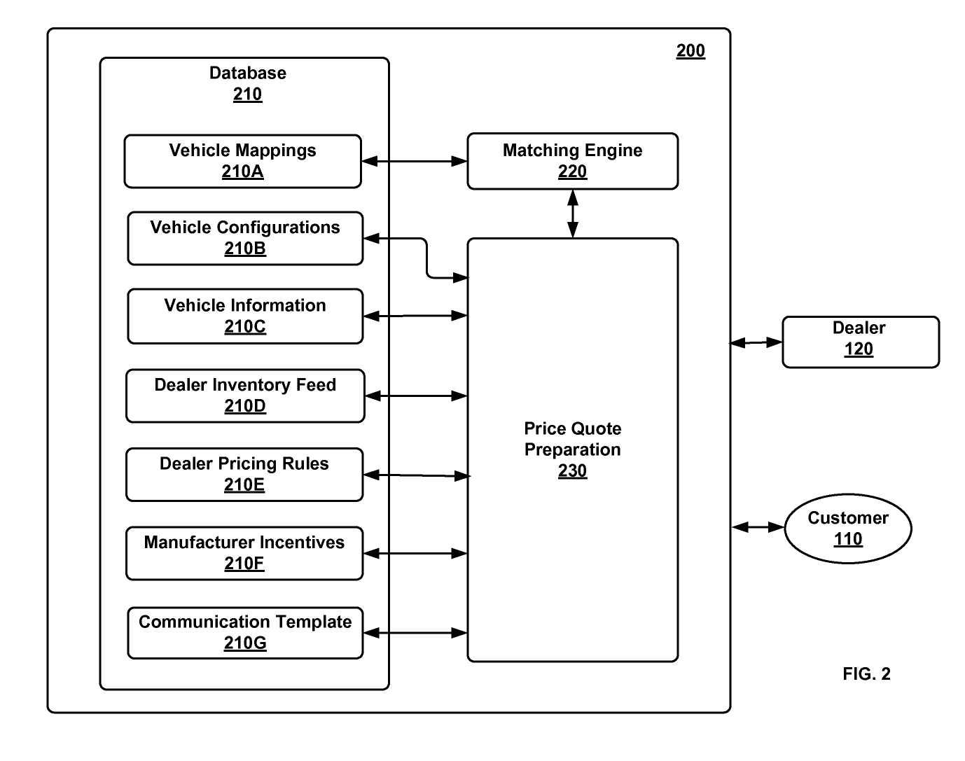

FIG. 1A illustrates an exemplary architecture for generating an automated price quote. The parties involved may include the customer 110, dealer (or seller) 120 of a product, and the quoting engine 200. In the illustrated embodiment, the customer 110 communicates with quoting engine 200, which in turn, can convey information to the dealer 120 through the dealer's customer relationship management (CRM)/Internet lead management (ILM) system.

FIG. 1B illustrates an alternative architecture for generating a price quote according to another embodiment of the present invention. Such an architecture may result from a plug-in model, in which price quoting in integrated into the CRM/ILM system of the dealer. As such, the customer communicates with the dealer's 120 CRM/ILM system, the CRM/ILM system communicates the issuance of the price quote to the quoting engine 200, the quoting engine 200 issues the price quote to consumer 120.

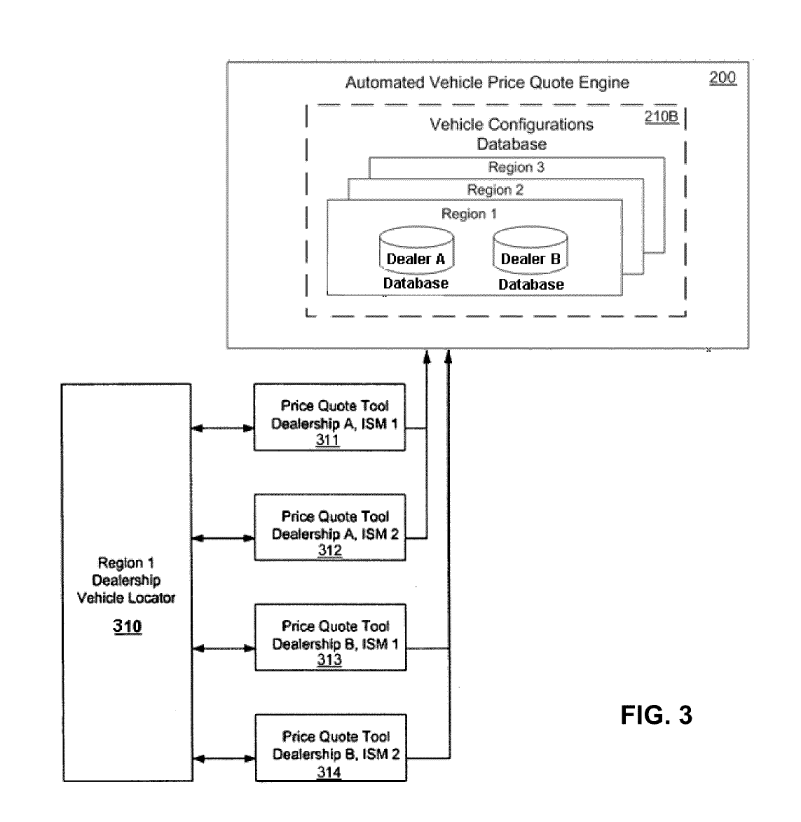

FIG. 2 illustrates an exemplary embodiment of a quoting engine system 200 for generating a price quote. The quoting engine 200 includes a database 210, a matching engine 220, and a price quote preparation engine 230. Database 210 stores information concerning various product specifications. If the product is a vehicle, for example, database 210 may store vehicle mappings 210A, vehicle configurations 210B, vehicle information 210C, information from dealer inventory feeds 210D, dealer pricing rules 210E, manufacturer incentives 210F, and communication templates 210G, as illustrated in FIG. 2.

Vehicle mappings database 210A includes various translations understood to be a particular vehicle by the quoting engine 200. For example, a customer 110 may request a particular vehicle (e.g., 2009 Toyota Corolla LE 4-door sedan), while the quoting engine 200 understands the same vehicle as a 2009 Toyota Corolla LE 4-dr SDN. Because the descriptions are slightly different, quoting engine 200 may map, translate, or otherwise understand that both descriptions apply to the same vehicle based on information stored under vehicle mappings database 210A:

2009 Toyota Corolla LE 4-dr SDN=2009 Toyota Corolla LE 4-Door Sedan

The matching is performed by matching engine 220. Once an incoming price quote request is received from the customer 110, a product description may be identified in the request and matched to a product description of one or more dealers 120 by matching engine 220. Matching engine 220 uses the information stored in vehicle mappings 210A to determine what product is being requested by the customer 110. In some embodiments, new and updated vehicle mappings may be added manually, automatically, or both, to vehicle mappings database 210A. Some embodiments may track manual mappings, determine that manual mapping has occurred a certain number of times, and store the particular mapping under mappings 210A for automatic mapping in the future.

Vehicle configurations database 210B includes information concerning specific products. Such information may be expressed as any combination of options or features associated with a vehicle identified by matching engine 220. The configurations may be stored in the form of a specific vehicle as uniquely identified by its VIN number (very specific) or vehicle configurations available at a given dealership or dealerships in a geographic region (less specific). For a given combination of “Year, Make, Model” or “Year, Make, Model, Trim,” vehicle configurations database 210B may list multiple vehicle configurations that will be included in the price quote. In some embodiments, new and updated configurations may be added to vehicle configurations database 210B due to the use of the quoting engine 200, just as new mappings may be added to vehicle mappings 210A.

Vehicle information database 210C includes further information and specifications for a given vehicle type. The information in 210C provides customer 110 of the vehicle price quote with the vehicle's description as well as the descriptions of the options, features, and equipment available and/or included on the quoted vehicles. For example, a customer 110 may request a particular make and model, but be unaware of what further options and features are available. Such information may be accessed from vehicle information 210C of the database 210 and provided to the customer 110, who can then submit a new price quote request for the same make and model, but with further specifications concerning options, features, etc.

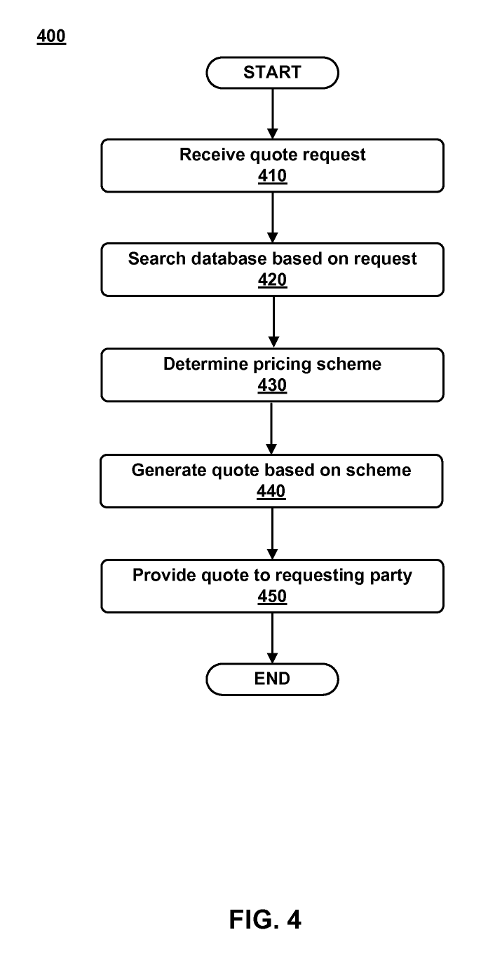

Dealer inventory feed database 210D includes lists of vehicles currently at a given dealer 120 along with information that may be obtained by decoding the vehicle identification number (VIN) number associated with each vehicle. This database is used to provide information relating to actual new and used vehicles available from a particular dealer 120 that may match the price quote request submitted by the customer 110. In some embodiments, available alternatives to the new vehicle may be determined and presented to the customer 110. Such alternatives may include higher-end models, lower-end models, as well as used/new alternatives. For example, a customer 110 requesting a price quote for a used vehicle may also be presented with price quotes for a new vehicle with the same (or similar) specifications, and vice versa. The information stored in dealer inventory feed database 210D may be received from multiple dealers in any geographic region. FIG. 3, described in further detail below, illustrate one way that information may be provided to data inventory feed database 210D.

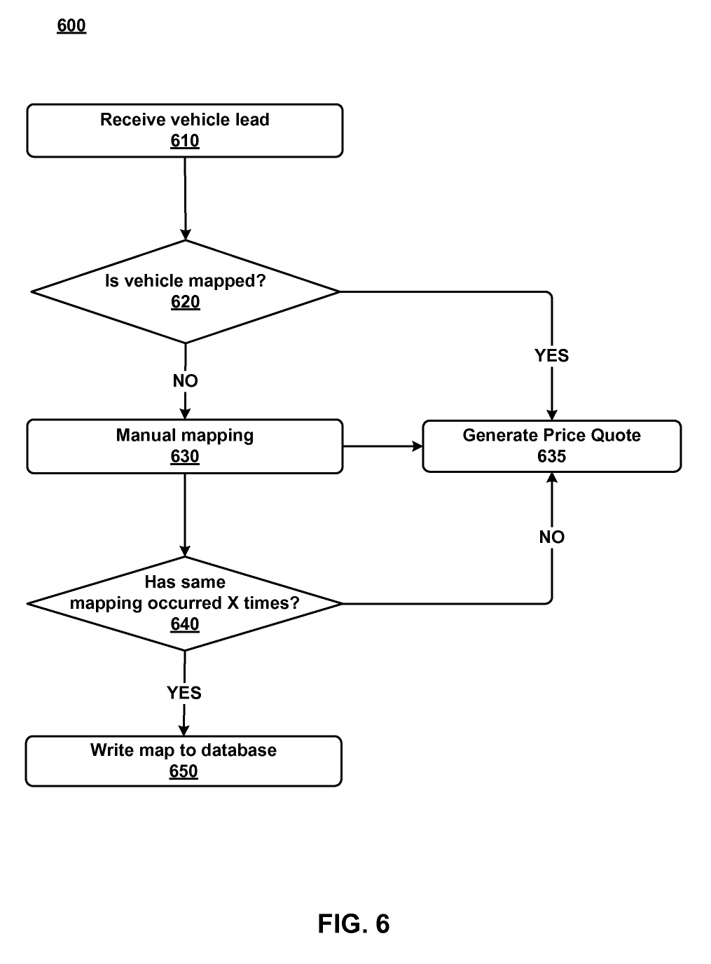

Dealer pricing rules database 210E includes rules and the pricing values by which the dealer 120 arrives at the final price of a given vehicle. These rules are stored in advance of an incoming vehicle price quote request. Examples of pricing rules and the application of such rules in providing an automated quote are described further with respect to FIG. 5.

Manufacturer incentive database 210F contains manufacturer incentives offered directly to customer 110. These incentives may include cash back rebates, special financing rates, or special lease rates to influence a customer's purchase decision.

Communication template database 210G is stored in advance of the issuance of a price quote. The template may contain information layout, copy, graphics or the like that may be used at the time a vehicle price quote request is issued. The communication method used to inform the customer 110 of a vehicle price quote may be e-mail, webpage, text message, mobile communication, and other forms of communication commonly used in the art.

FIG. 3 illustrates an exemplary architecture for receiving dealer information. The availability of a product by configuration, as well as by dealer 120 or dealers 120 in a geographic region, may need to be determined before generation of a price quote. In some cases such as the customer 110 calling the dealer 120 by telephone or requesting an updated/refined price quote based on new information provided to the dealer 120, a dealer 120 may request the issuance of a price quote on behalf of a customer 110.

The dealer 120 as part of requesting the issuance of a price quote to consumer 110 may select an existing vehicle configuration from vehicle configurations database 210B or create a new vehicle configuration if needed. Alternatively, the request for issuing a price quote by dealer 120 may be based on a regional vehicle search using a tool such as a regional vehicle locator 310 provided by, for example, the original equipment manufacturer (OEM), prior to submitting the price quote request. Regional vehicle locator 310 operates in conjunction with inventory supply management (ISM) systems at one or more dealers 120 to provide dealer cost and inventory availability of a vehicle manufactured by OEM. Multiple uses of the regional vehicle locator 130 provides frequent updates 311-314 concerning such dealer cost and inventory of one or more dealers 120 in a geographic region. As such, the information concerning inventory of vehicles available across dealerships within a particular region may be continuously provided to quoting engine 200. Upon locating a vehicle in the region, the dealer 120 may submit a price quote request on behalf of the customer 110 based on the configuration of the vehicle retrieved from the regional vehicle locator 130. As such, the particular vehicle configuration is passed along to the quoting engine 200 and stored in vehicle configurations database 210B.

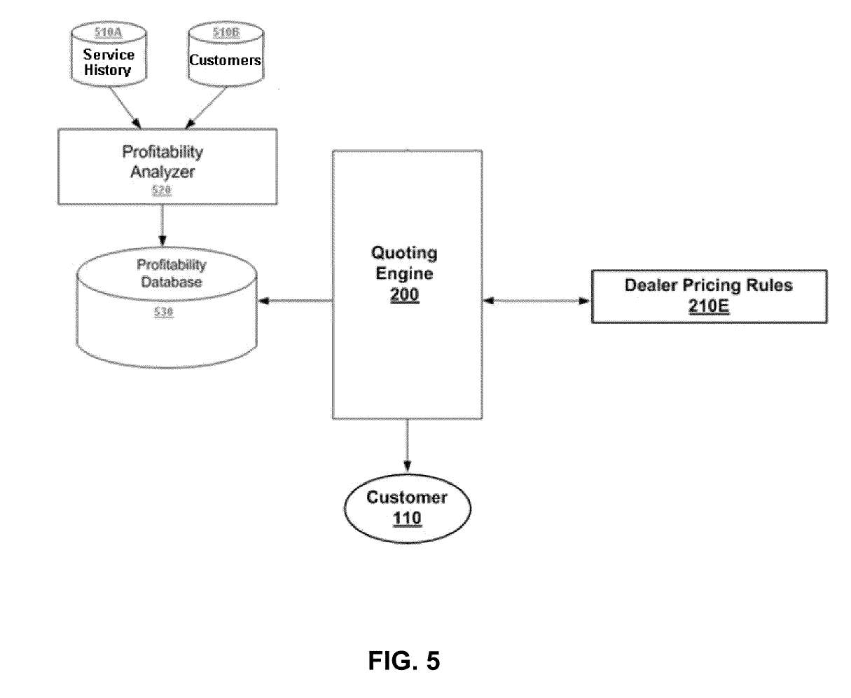

FIG. 4 illustrates an exemplary method 400 for generating a price quote. Method 400 may include receiving a quote request from a user, searching the database based on the request, determining one or more dealers with available product, determining a pricing scheme for the available product, generating a price quote based on the determined pricing scheme, and providing the generated quote to consumer 110.

In step 410, a price quote request is received. Such a price quote request may be sent directly from a customer 110 or from a dealer 120, who may be submitting the price quote request on behalf of one or more customers 110. The price quote request may indicate a geographic region of interest (i.e., city/state, zip code, etc.) and a particular product of interest. The indication concerning the product may include one or more product specifications.

In step 420, database 210 may be searched based on information included in the request (i.e., geographic information, product specification(s)). A search may include determining the information available in database 210 A-G on the following questions:

What is the specified product,

Whether the specified product is available in the specified geographical region, and from what dealers,

What other specifications are available for the specified product,

How many units of the specified product are available from a dealer,

How much the dealer is quoting for the specified product,

Whether any alternatives exist, and any cost adjustment for the alternative,

Whether the specified product qualifies for any manufacturer incentives (e.g., cashback rebates, special financing options, special lease rates),

Which sales representative at a dealership is issuing the price quote.

As part of the search, the product specification provided in the price quote request is compared to the products information stored in mappings 210A. For example, a price quote request concerning a particular car is automatically mapped/translated to a product description understood by quoting engine 200. While it is possible for a customer 110 to specify a desired product configuration, the product manufacturer (e.g., OEM) may not have built such a configuration. In such a case, an alternative/equivalent product may be selected. The particular product configuration (or alternative/equivalent) can then be determined based on a preprogrammed selection algorithm. Preprogramming may be based on default configurations and/or customized by dealer 120, OEM , etc.

In step 430, a relevant pricing scheme is determined for the dealer(s) 120. A pricing scheme is a set of one or more pricing rules for a particular vehicle configuration. A particular dealer 120 may wish to specify a set of pricing rules. The pricing rules may include absolute selling price, pricing relative to the product's manufacturer-suggested retail price (MSRP), or pricing relative to the dealer's invoice price. Dealer invoice pricing may be obtained from the dealership in absolute fashion or through a formulaic calculation. The dealer 120 may also specify different rules for different configurations. As such, multiple pricing schemes may be associated with a particular dealer 120. In step 430, a pricing scheme is identified from possibly multiple pricing schemes by dealer 120 and determined as being relevant to the specified product and customer. Pricing schemes are discussed in further detail below with respect to FIG. 5.

In step 440, a price quote is generated based on the pricing scheme identified in step 430. The pricing scheme identified in step 440 is applied to determine a price quote. A price quote request may include multiple specifications for the product, and each specification may be associated with a pricing rule in the pricing scheme. For example, a customer 110 may request a vehicle of a particular year, make, model, trim, and other features. A dealer 120 may specify pricing rules for each product specification in its pricing scheme, so each relevant rule is identified and applied to generate the price quote. Further, customer incentive information may also be provided by manufacturer incentives 210F in database 210 and applied to generate the price quote. This information may include but is not limited to cash back rebates, special financing rates, or special lease rates. In some instances, special pricing rules may apply. For example, a dealer 120 may be having a sale during a particular weekend in which a friends-and-family discount is available. Such special pricing rules may also be taken into account in the generation of the price quote.

In step 450, the price quote generated in step 440 is provided to consumer 110. As discussed previously, the requesting party may be a customer 110 or a dealer 120. In addition to the price quote, other information may be provided to assist the customer 110 in making a decision. For example, a detailed description of the product (including various other specifications available) may be provided from vehicle information 210C stored in database 210. Additional information may also be included, including price quotes for alternative and/or equivalent products. Such products may differ from the specified product based on degree of use, number of options included, etc. For example, a price quote for a new product with a particular specification may be accompanied by one or more price quotes for a used product, a new product with different specification(s), etc.

Further, if the dealership wishes to indicate that the price quote has been sent on behalf of a particular individual (i.e., a sales representative), such information may also be sent along with the price quote. Such information, along with dealer-specific information (i.e., address, operating hours) may be provided by communication template 210G stored in database 210. The information for the vehicle price quote is incorporated into the template dynamically to produce the desired vehicle price quote communication. The price quote (and any accompanying information) may then be issued via e-mail, web, SMS, text, mobile communication and others known in the art. If the price quote is issued to a customer 110, a copy may also be sent to the identified dealer 120.

FIG. 5 illustrates an exemplary implementation of a pricing scheme. A dealership may provide quoting engine 200 with pricing rules for dealing with various customers 110 shopping for a particular product. These pricing rules may be stored in dealer pricing rules 210E in database 210. An exemplary pricing rule may result in special pricing based on the source of the price quote request (e.g., American Automobile Association (AAA)) website. A pricing rule may have strategic and practical applications for a dealership. For example, a dealer may offer a discount based on the vehicle shopper's zip code contained in the vehicle price quote request. By issuing a lower price, a dealership may entice a shopper to drive a greater distance to do business with the dealership.

A pricing rule may be based on past profitability or perceived future profitability with respect to a certain groups of customer 110. The quoting engine 200 allows for price quotes to incorporate factors related to profitability by customer 110. For example, if customer 110 purchased a vehicle and had it serviced regularly by a dealership, customer 110 would be considered more profitable than a customer who did not purchase and/or service her vehicle at the dealership. If customer 110 purchases her next vehicle from the same dealership, customer 110 may be considered a profitable customer. By offering a lower price quote to customer 110, the dealership may encourage this profitable customer 110 to purchase from the same. Likewise, previous customers 110 may be analyzed to determine profitability by obtaining sales and service information from a dealership database, such as service history database 510A or customer sales database 510B as pictured in FIG. 5. In some embodiments, the profitability of a customer 110 may be determined via a profitability analyzer 520 and stored in a profitability database 530. Profitability database 530 may store information relating to customer profitability in the form of profitability indices. For example, a profitability index may be a rating based on a numeric scale incremented from 1 to 4, with 1 as the least profitable and 4 as the most profitable. This index may be accessible to the quoting engine 200, which in turn may access the dealer pricing rules database 210E to associate a percentage discount with each rating.

For example, customer 110 submits a request for a price quote to a dealership that provides price quotes based on customer profitability. The quoting engine 200 queries the profitability database 530 for to determine if customer 110 is present in the profitability database. In this example, the query may return a match with a high level of profitability for customer 110. The dealer pricing rules 210E may be searched, and an associated pricing discount applied to the price quote provided to customer 110. The price quote is issued containing the applied discount based on customer profitability.

Some of the above-described functions can be composed of instructions that are stored on storage media (e.g., computer-readable medium). The instructions may be retrieved and executed by the processor. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable medium” and “computer-readable media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A method for automated price quote generation, the method comprising:
maintaining a database in memory, the database storing information concerning a plurality of available vehicles associated with a dealer inventory, the stored information including information regarding a plurality of features associated with each vehicle;
receiving a price quote request from a requesting party concerning a requested vehicle, the price quote request indicating a geographic location and a specification regarding a feature of the requested vehicle;
executing instructions stored in memory, wherein execution of the instructions by a processor of the computing device:
retrieves a set of search results from the database, the set of search results including available vehicles in or around the geographic location and matching the specification provided by the price quote request, and
generates a price quote for each available vehicle in the search results, the price quote calculated based on a predefined pricing rule associated with the dealer of the available vehicle; and
providing a response including the generated price quote to the requesting party.

2. The method of claim 1, wherein the specification is selected from the group consisting of make, model, year, trim, color, body style, vehicle segment, duty type, option, use level, inventory age, equipment level, and vehicle identification number (VIN).

3. The method of claim 2, wherein the predefined pricing rule adjusts the calculation of the price quote based on the specification.

4. The method of claim 1, wherein the predefined pricing rule adjusts the calculation of the price quote based on information specific to the dealer.

5. The method of claim 1, wherein the predefined pricing rule is further associated with a specified time frame during which the predefined pricing rule is available and wherein the price quote is generated within the specified time frame.

6. A computer-readable storage medium having embodied thereon a program, the program being executable by a processor to perform a method for automated price quote generation, the method comprising:
maintaining a database for storing information concerning a plurality of available vehicles associated with a dealer inventory, the stored information including information regarding a plurality of features associated with each vehicle;
receiving a price quote request from a requesting party, the price quote request concerning a requested vehicle and comprising information concerning a geographic location and a specification regarding a feature of the requested vehicle;
retrieving a set of search results from the database, the set of search results including available vehicles in or around the geographic location and meeting the specification provided by the price quote request;
generating a price quote for each vehicle found in the search, the price quote based on a predefined pricing rule associated with the dealer of the vehicle; and
providing a response including the generated price quote to the requesting party.
